(19) United States
(12) Patent Application Publication
(10) Pub. No.: US 2013/0032740 A1
(43) Pub. Date: Feb. 7, 2013

(54) Electromagnetic water supply value

(71) Applicant: Gwan Ho Ro, Seoul (KR)

(72) Inventor: Gwan Ho Ro, Seoul (KR)

(21) Appl. No.: 13/317,467

(22) Filed: Oct. 19, 2011

(30) Foreign Application Priority Data
Aug. 4, 2011 (KR) 2011-77551

(51) Int. Cl. F16K 31/02

(52) U.S. Cl. 251/129.15

(57) ABSTRACT

In an electromagnetic water supply valve, a body includes a chamber having a valve seat disposed between an inlet and an outlet. A diaphragm and a diaphragm holder are stacked on the valve seat to define a pressure chamber. An electromagnet unit is disposed on the body, closing the pressure chamber. The valve controls the supply of water in response to the electromagnet unit, so that water is introduced into or discharged from the pressure chamber. An electric circuit-forming coil is wound on a bobbin. The lower end of the bobbin is hermetically coupled to the diaphragm. A magnetic induction member seals the upper portion of a hollow section of the bobbin, and generates magnetic force in cooperation with the coil. A plunger is driven to open and close the water supply passage. The electromagnetic water supply valve increases electrical efficiency with a decreased number of components.

### CROSS REFERENCE TO RELATED APPLICATION

The present application claims priority from Korean Patent Application Number 10-2011-77551 filed on Aug. 4, 2011, the entire contents of which application are incorporated herein for all purposes by this reference.

### BACKGROUND OF THE INVENTION

1. Field of the Invention

The present invention relates to an electromagnetic water supply valve that controls the supply of water using electromagnets, and more particularly, to an electromagnetic water supply valve that increases electrical efficiency with a decreased number of components.

2. Description of Related Art

Electromagnetic water supply valves, which control the supply of water using electromagnets, are used in various products, such as washing machines, refrigerators, beverage vending machines, dishwashers, boilers, etc., which require the automatic supply of water and to which automatic water supply devices are applied.

Such an electromagnetic water supply valve is disposed on the terminal of a water transportation system, such as a water supply pipeline, or the water inlet side of a machine that uses water. As shown in FIG. 1, the electromagnetic water supply valve includes a body 100, which has defined therein a passage of water extending from an inlet to an outlet. The valve also has an electromagnet unit 200, which is disposed on the passage of water extending from the inlet to the outlet of the body 100 to control the supply of water into the body 100.

The body 100 has, in respective opposite sides thereof, an inlet 110, through which water enters, and an outlet 120, through which water exits. A chamber 130 is disposed at a suitable position between the inlet 110 and the outlet 120, and has a valve seat 140, which connects the inlet 110 and the outlet 120.

A diaphragm 150, a diaphragm holder 160 and the electromagnet unit 200 are sequentially disposed on the valve seat 140 inside the chamber 130 of the body 100 to thus divide the chamber 130 into upper and lower sections, thereby defining a pressure chamber 132 in the upper section.

The diaphragm 150 and the diaphragm holder 160 have defined therein an inflow passage 164 in a side portion of the valve seat 140 such that the inflow passage 164 extends through eccentric and central portions of the diaphragm 150 and the diaphragm holder 160, and a water supply passage 162 is formed in the central portion of the diaphragm 150 and the diaphragm holder 160. In response to whether or not the electromagnet unit 200 operates, the inflow passage 164 connects the chamber 130 with the pressure chamber 132, and the water supply passage 162 connects the pressure chamber 132 with the outlet 120.

The electromagnet 200 includes a bobbin 210, on which an electric circuit-forming coil 220 is wound. The bobbin 210 has defined therein a hollow section 212, which is identical with the pressure chamber 132 in the body 100. A cap 230 is disposed inside the hollow section 212 of the bobbin 210, with the lower end thereof being coupled with the diaphragm 150 to form the pressure chamber 132. A plunger 260 is disposed inside the cap 230, is supported by an elastic member 240, and has a packing 260, which opens and closes the water supply passage 162, in the lower portion thereof. Sleeves 250, which are made of a magnetic induction metal, are disposed on the outer circumference of the cap 230, and are divided into upper and lower sleeves. The sleeves 250 cooperate with the elastic member 240 to drive up and down the plunger 260.

The electromagnet unit 200 also includes anode and cathode terminals 290, which supply electric power to the coil 220. One end of each terminal 290 is connected to the coil 220, and the other end of the terminal 290 is connected to a power source.

The electromagnet 200 is fixed to the body 100 using a metal angle 280 by surrounding the outer surface of the terminals 290 using a cover layer 270, except for some parts of the terminals 290, such that the terminals 290 are sealed from the external environment, and then by aligning the hollow section 212 of the bobbin 210 with the pressure chamber 132.

With the structure described above, the electromagnetic water supply valve serves to supply a predetermined amount of water by repeatedly controlling the supply of water in response to the supply of electric power to the electromagnet unit 200.

That is, if electric power is not supplied to the electromagnet unit 200, the plunger 260 continues to shut off water supply as a packing 262 in the lower end of the plunger 260 closes the water supply passage 162 of the diaphragm holder 160 under the weight of the plunger 260 and the downward elastic force of the elastic member 240, so that water in the pressure chamber 132 does not flow toward the outlet 120 through the water supply passage 162.

When electric power is applied to the electromagnet unit 200 in the state in which the supply of water is shut off, i.e. in the state in which external electric power is applied to the coil 220 through the terminals 290, the coil 220 reacts with the magnetic induction sleeves 250, which are positioned on the outer circumference of the cap 230, thereby generating electromagnetic force that drives up the plunger 260, which is positioned inside the cap 230 made of resin.

The plunger 260 is then moved up to open the water supply passage 162, which has been closed by the packing 262. At the same time, water that has been contained in the pressure chamber 132 rapidly flows through the water supply passage 162 to the outlet 120, which is at atmospheric pressure, thereby dropping the pressure in the pressure chamber 132 to an atmospheric state. In this way, the intended supply of water is realized.

When the supply of power to the electromagnet unit 200 is suspended after the water is supplied, the plunger 260 is elastically driven down by the elastic member 240 so that the packing 262 closes the water supply passage 162. Then water flows through the inflow passage 164 into the pressure chamber 132, the pressure of which has been decreased to atmospheric pressure due to the supply of water, thereby increasing the pressure inside the pressure chamber 132 so that the pressure chamber 132 stays in a closed state.

In the water supply valve of the related art, the magnetic induction sleeves 250 are positioned on the outer circumference of the cap 230 made of resin so that magnetic force from the sleeves 250 and the coil 220 wound on the bobbin 210 is applied to the plunger 260 through the interior of the cap 230. However, the cap 230 interferes with the action of the magnetic force to the plunger 260.

As another problem, when the sleeves 250 are positioned on the upper and lower portions of the outer circumference of the cap 230, or are disposed between the cap 230 and the bobbin 210, the number of processes and the number of parts necessary for systemic assembly increase, thereby making the fabrication process expensive and complicated.

The information disclosed in this Background of the Invention section is only for the enhancement of understanding of the background of the invention, and should not be taken as an acknowledgment or any form of suggestion that this information forms a prior art that would already be known to a person skilled in the art.

### BRIEF SUMMARY OF THE INVENTION

Various aspects of the present invention provide an electromagnetic water supply valve in which a plunger that moves up or down depending on the presence of magnetic force and a magnetic induction element are positioned in the same space in order to increase the efficiency of magnetic force, thereby improving electrical characteristics.

Also provided is an electromagnetic water supply valve in which the number of parts is decreased, thereby simplifying the process of assembly and maintenance and reducing the product cost.

In an aspect of the present invention, the electromagnetic water supply valve includes a body, the body including a chamber, which has a valve seat disposed at a predetermined position between an inlet and an outlet; a diaphragm and a diaphragm holder, the diaphragm and the diaphragm holder being stacked on the valve seat to define a pressure chamber; and an electromagnet unit, which is disposed on the body such that the pressure chamber is closed. The valve controls the supply of water in response to whether or not the electromagnet unit operates, so that water is introduced into or discharged from the pressure chamber through a water supply passage and an inflow passage, which are defined in the diaphragm and the diaphragm holder. The electromagnet unit includes a bobbin, on which an electric circuit-forming coil is wound. The lower end of the bobbin is hermetically coupled to the diaphragm, thereby sealing the pressure chamber. A magnetic induction member made of a metal seals the upper portion of a hollow section of the bobbin, and serves to generate magnetic force in cooperation with the coil when electric power is applied thereto. A plunger has a packing, is supported on the magnetic induction member by an elastic member, and is driven up and down in response to magnetic force to thereby open and close the water supply passage using the packing.

As set forth above, the magnetic induction member, which generates magnetic force in response to whether or not external power is applied to the hollow section of the bobbin and the plunger, which reacts with the induction member, are provided in the same space so that the plunger is pulled by direct influence of the magnetic force, thereby reducing the amount of energy that is required to generate the magnetic force.

In addition, the combination of the bobbin, the diaphragm and the magnetic induction member provides the pressure chamber and the space in which the plunger moves up and down. This advantageously reduces the number of parts, thereby simplifying the assembly process and maintenance and reducing costs.

### BRIEF DESCRIPTION OF THE DRAWINGS

FIG. 1 is a cross-sectional view showing the structure of an electromagnetic water supply valve of the related art;

FIG. 2A is a cross-sectional view showing the structure of an electromagnetic water supply valve according to an embodiment of the present invention; and

FIG. 2B is a cross-sectional view showing the operation of the electromagnetic water supply valve shown in FIG. 2A.

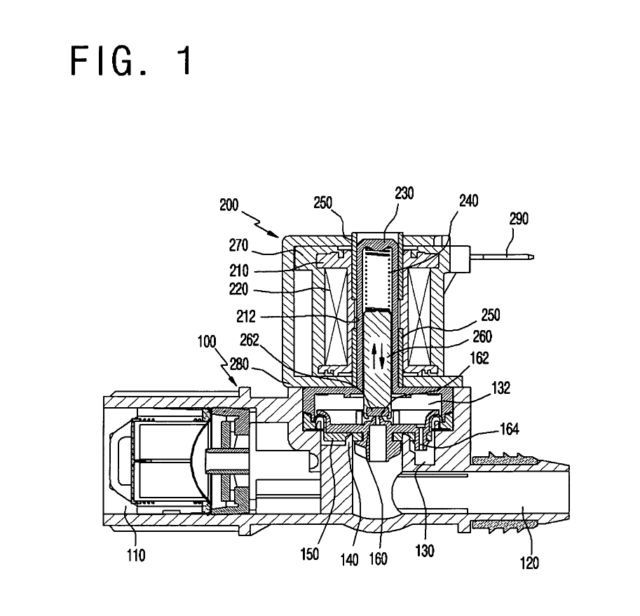

### DETAILED DESCRIPTION OF THE INVENTION

Reference will now be made in detail to various embodiments of the present invention, examples of which are illustrated in the accompanying drawings and described below. While the invention will be described in conjunction with exemplary embodiments thereof, it is to be understood that the present description is not intended to limit the invention to those exemplary embodiments. On the contrary, the invention is intended to cover not only the exemplary embodiments, but also various alternatives, modifications, equivalents and other embodiments that may be included within the spirit and scope of the invention as defined by the appended claims.

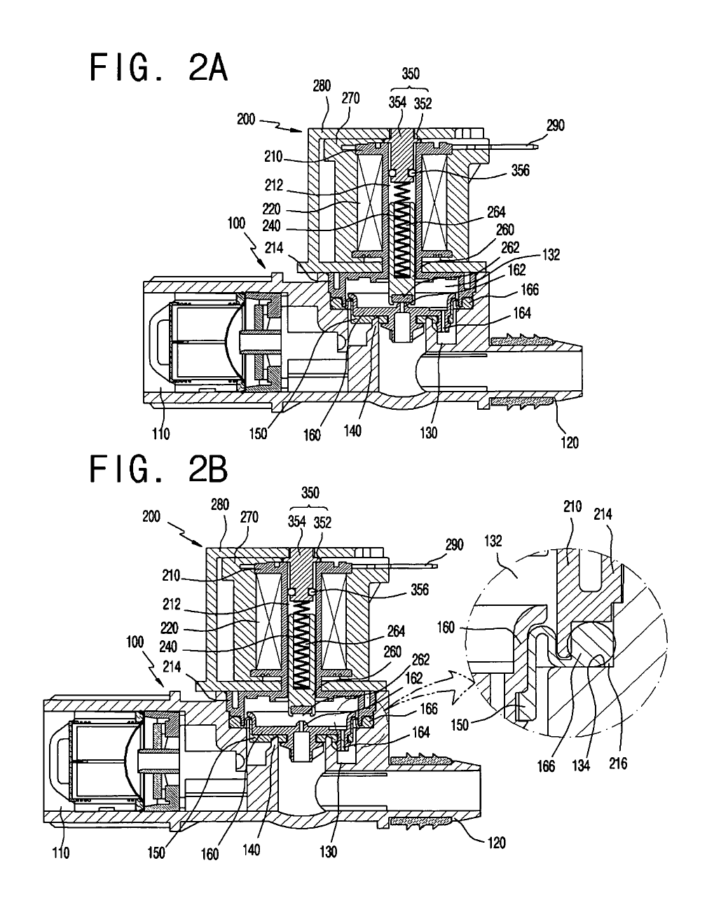

Referring to FIG. 2A and 2B, the electromagnetic water supply valve of this embodiment includes a body 100, which has a chamber 130 with a valve seat 140 between an inlet 110 and an outlet 120. The body 100 also has a pressure chamber 132, which is defined by a diaphragm 150 and a diaphragm holder 160 stacked on the valve seat 140. An electromagnet unit 200 is disposed on the body 100 such that the pressure chamber 100 is closed. With this structure, the valve controls the supply of water in response to whether or not the electromagnet unit 200 operates. Specifically, water is introduced into or discharged from the pressure chamber 132 through a water supply passage 162 and an inflow passage 164, which are defined in the diaphragm 150 and the diaphragm holder 160.

In this structure, a description of the body 100 will be omitted, since its structure is well known in the art. However, the electromagnet 200, which is the characteristic feature of the present invention, and is assembled with the body 100, will be described in detail in light of its structure, assembly and operation.

The electromagnet unit 200 includes a bobbin 210, on which an electric circuit-forming coil 220 is wound. The lower end of the bobbin 210 is hermetically coupled to the diaphragm 150, thereby sealing the pressure chamber 132. A magnetic induction member 350 made of a metal seals the upper portion of a hollow section 212 of the bobbin 210, and serves to generate magnetic force in cooperation with the coil 220 when electric power is applied thereto. A plunger 260 has a packing 262, is supported on the magnetic induction member 350 by an elastic member 240, and is driven up and down in response to magnetic force to thereby open and close the water supply passage 162 using the packing 262.

The electromagnet unit 200 also includes anode and cathode terminals 290, which supply electric power to the coil 220. One end of each terminal 290 is connected to the coil 220, and the other end of the terminal 290 is connected to a power source.

The electromagnet 200 is fixed to the body 100 using a metal angle 280 by surrounding the outer surface of the terminals 290 using a cover layer 270, except for some parts of the terminals 290, such that the terminals 290 are sealed from the external environment, and then by aligning the hollow section 212 of the bobbin 210 with the pressure chamber 132.

Specifically, the bobbin 210, the coil 220 wound on the bobbin 210, and the cover layer 270 are contained in the angle 280, and in this state, the lower end of the angle 280 is placed on and fixed to the upper end of the body 100 using a typical coupling method, such as thermal bonding or bolting. In this fixing structure, the lower end of the angle 280 presses the lower end of the bobbin 210, which forms the pressure chamber 132, thereby providing pressure to the bobbin 210, so that the bobbin 210 is brought into close contact with the diaphragm 150.

The plunger 260 and the magnetic induction member 350 are supported by the elastic member 240. In order for the elastic member 240 to provide stable support and be lightweight, the plunger 260 has a recess 264. The recess 264 is open upwards such that the lower portion of the elastic member 240 is inserted into the recess 264.

The magnetic induction member 350 made of a metal includes a magnetic induction section 352, which is hermetically inserted into the hollow section 212 of the bobbin 210, with an O-ring 356 fitted on the outer circumference of the magnetic induction section 352. A flange 354 is formed on the upper portion of the magnetic induction section 352, and is coupled to an adjacent face of the hollow section 212 of the bobbin 210 using a typical coupling structure, such as spot welding or bolting.

That is, the magnetic induction member 350 hermetically closes the upper end of the hollow section 212, thereby sealing the pressure chamber 132, which communicates with the hollow section 212, from the outside, and directly pulls the plunger 260 upwards using magnetic force generated through a reaction with the coil 220.

The pressure chamber 132 has a pushing edge 134 on the sidewall thereof. The inner side of the diaphragm 150, which is pressed by the lower end of the bobbin 210, is in close contact with the pushing edge 134. A sealing space 216, into which the upper end of the diaphragm 150 is introduced, is defined between the pushing edge 134 and the bobbin 210. The upper end of the diaphragm 150, which is introduced into the sealing space 216, forms a compression surface, thereby providing a sealing portion 166 as an element that maintains a hermetic seal.

Although the sealing portion 166 has a circular cross section in this embodiment, this is not intended to limit the present invention. The sealing portion 166 may be implemented in a form such that it is disposed between the bobbin 210 and the inner surface of the pressure chamber 132, which define the sealing space 216, and may have a volume such that its shape can be deformed under a predetermined pressure.

The bobbin 210 has an elastic portion 214 adjacent to the lower end thereof, the elastic portion 214 being tight contact with the inner surface of the pressure chamber 132 to establish the tightness of contact with the pressure chamber 132. The elastic portion 214 is formed by bending the lower portion, which is made of resin.

In the electromagnetic water supply valve of this embodiment as configured above, as shown in FIG. 2A, when electric power is not supplied to the electromagnetic unit 200, the packing 262 in the lower end of the plunger 260 closes the water supply passage of the diaphragm holder 160 due to the downward elastic force of the elastic member 240, the upper end of which is supported by the magnetic induction member 350. Consequently, the water supply continues to be suspended, i.e. water in the pressure chamber 132 is prevented from flowing toward the outlet 120 through the water supply passage 162.

In this state, electric power is applied to the electromagnet unit 200. Then, as shown in FIG. 2B, external power is applied to the coil 220 through the terminal 290 and reacts with the magnetic induction member 350, which is located in the hollow section 212 of the bobbin 210, thereby generating electromagnetic force that directly drives the plunger 260 upwards.

Consequently, the plunger 260 moves up to open the water supply passage 162, which has been closed by the packing 262. At this time, water, which has been contained in the pressure chamber 132, rapidly flows through the water supply passage 162 toward the outlet 120, which is at atmospheric pressure, thereby dropping the pressure in the pressure chamber 132 to an atmospheric state. In this way, the intended supply of water is realized.

When the supply of power to the electromagnet unit 200 is suspended after the supply of water, the plunger 260 is driven down by the elastic member 240 so that the packing 262 in the lower end of the plunger 260 closes the water supply passage 162. Then water flows through the inflow passage 164 into the pressure chamber 132, the pressure of which has decreased to atmospheric pressure due to the supply of water, thereby increasing the pressure inside the pressure chamber 132, so that the pressure chamber 132 remains in a closed state.

The foregoing descriptions of specific exemplary embodiments of the present invention have been presented for the purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An electromagnetic water supply valve comprising:
a body, wherein the body comprises:
a chamber, which has a valve seat disposed at a predetermined position between an inlet and an outlet;
a diaphragm; and
a diaphragm holder, the diaphragm and the diaphragm holder being stacked on the valve seat to define a pressure chamber; and
an electromagnet unit, wherein the electromagnet unit is disposed on the body such that the pressure chamber is closed, wherein the valve controls a supply of water in response to whether or not the electromagnet unit operates, so that water is introduced into or discharged from the pressure chamber through a water supply passage and an inflow passage, which are defined in the diaphragm and the diaphragm holder,
wherein the electromagnet unit includes a bobbin, on which an electric circuit-forming coil is wound, wherein a lower end of the bobbin is hermetically coupled to the diaphragm, thereby sealing the pressure chamber, wherein a magnetic induction member made of a metal seals an upper portion of a hollow section of the bobbin, and serves to generate magnetic force in cooperation with the coil when electric power is applied thereto, and wherein a plunger has a packing, is supported on the magnetic induction member by an elastic member, and is driven up and down in response to magnetic force to thereby open and close the water supply passage using the packing.

2. The electromagnetic water supply valve of claim 1, wherein the plunger has a recess into which the elastic member is inserted such that the elastic member maintains stable support.

3. The electromagnetic water supply valve of claim 1, wherein the magnetic induction member comprises:
a magnetic induction section, the magnetic induction section being hermetically inserted into the hollow section of the bobbin, with an O-ring being fitted on an outer circumference thereof; and
a flange formed on an upper portion of the magnetic induction section, the flange being coupled to an adjacent face of the hollow section of the bobbin.

4. The electromagnetic water supply valve of claim 1, wherein the pressure chamber comprises:
a pushing edge, wherein an inner side of the diaphragm, which is pressed by the lower end of the bobbin, is in close contact with the pushing edge; and
a sealing space between the pushing edge and the bobbin, with an upper end of the diaphragm being introduced into the sealing space, wherein the upper end of the diaphragm introduced into the sealing space forms a sealing portion.

5. The electromagnetic water supply valve of claim 4, wherein the sealing portion has a circular cross section.

6. The electromagnetic water supply valve of claim 1, wherein the bobbin has an elastic portion adjacent to the lower end thereof, the elastic portion being tight contact with an inner surface of the pressure chamber to establish tightness of contact with the pressure chamber.
